(19) United States
(12) Patent Application Publication
(10) Pub. No.: US 2022/0269935 A1
(43) Pub. Date: Aug. 25, 2022

(54) Personalizing Digital Experiences Based On Predicted User Cognitive Style

(71) Applicant: Adobe Inc., San Jose, CA (US)

(72) Inventors: Manoj Ghuhan Arivazhagan, Karur (IN); Samanway Sadhu, Asansol (IN); Sahil Dhull, Kurukshetra (IN); Niyati Himanshu Chhaya, Hyderabad (IN); Munipalle Sai Nikhila, HYDERABAD (IN)

(73) Assignee: Adobe Inc., San Jose, CA (US)

(21) Appl. No.: 17/182,734

(22) Filed: Feb. 23, 2021

(51) Int. Cl. G06N 3/08; G06N 3/04; H04L 29/08

(52) U.S. Cl. CPC G06N 3/08; G06N 3/0481; G06N 3/0445; H04L 67/02; G06F 3/0484

(57) ABSTRACT

A digital experience personalization system monitors user interaction with content during a current browsing session. The digital experience personalization system generates user interaction information, which includes a description of the content with which the user interacted during the current browsing session, an indication of how long the user interacted with the content, and an indication of the type of the user interaction (e.g., clicking on content, scrolling through content, hovering over content). The digital experience personalization system employs a cognitive style prediction module to analyze the user interaction information and generate a prediction of a cognitive style the user prefers for consuming content. Subsequent content (e.g., during the current browsing session) is personalized to the user in accordance with the predicted cognitive style of the user.

### BACKGROUND

As computer technology has advanced, computing devices have become increasingly commonplace in our lives. One use for our computing devices is consuming content, such as webpages, email, social media, and so forth. While having access to this content has its advantages, problems remain in providing this content to users for consumption. One such problem is that different users prefer to consume content in different manners. For example, some users prefer to consume content that is in a text modality while other users prefer to consume content that is in a video modality. Furthermore, oftentimes the user is not presented with a choice as to which modality he prefers to consume content in. Accordingly, situations arise in which conventional content display applications display content in a modality other than the modality preferred by the user, resulting in user dissatisfaction and frustration with their computers and applications.

### SUMMARY

To mitigate the disadvantages of conventional content display solutions, a digital experience personalization system as implemented by a computing device is described to provide personalizing digital experiences based on predicted user cognitive style. Interaction by a user with content on one or more web pages during a current browsing session is monitored. Content information describing the content is generated and user interaction information including a description of the monitored interaction by the user with the content and the content information describing the content is generated. A machine learning system determines a cognitive style prediction indicating a cognitive style preferred by the user for consuming content while browsing web pages by extracting features from both the user interaction information and the content information, and classifying the extracted features to generate the cognitive style prediction for one or more of multiple dimensions. A digital experience is caused to be personalized to a user by personalizing content in the digital experience to the user based on the cognitive style prediction for the user.

In one or more implementations, a known cognitive style for the user is also received. The machine learning system is further trained by updating weights or values of hidden states of the machine learning system to minimize a loss between the cognitive style prediction and the known cognitive style for the training user.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the personalizing digital experiences based on predicted user cognitive style described herein.

FIG. 2 is an illustration of an example architecture of a digital experience personalization system.

FIG. 3 is an illustration of an example architecture of cognitive style prediction machine learning system.

FIG. 4 illustrates content that is personalized to a user in response to the digital experience personalization system determining that the cognitive style of the user is analytic rather than holistic.

FIG. 5 illustrates content that is personalized to a user in response to the digital experience personalization system determining that the cognitive style of the user is holistic rather than analytic.

FIG. 6 is a flow diagram depicting a procedure in an example implementation of personalizing digital experiences based on predicted user cognitive style.

FIG. 7 is a flow diagram depicting a procedure in another example implementation of personalizing digital experiences based on predicted user cognitive style.

FIG. 8 illustrates an example system including various components of an example device that is implemented as any type of computing device as described and/or utilized with reference to FIGS. 1-7 to implement aspects of the techniques described herein.

### DETAILED DESCRIPTION

Overview

Personalizing digital experiences based on predicted user cognitive style is discussed herein. Generally, a digital experience personalization system monitors user interaction with content during a current browsing session. The digital experience personalization system generates user interaction information, which includes a description of the content with which the user interacted during the current browsing session, an indication of how long the user interacted with the content, and an indication of the type of the user interaction (e.g., clicking on content, scrolling through content, hovering over content). The digital experience personalization system employs a cognitive style prediction module to analyze the user interaction information and generate a prediction of a cognitive style the user prefers for consuming content. Subsequent content (e.g., during the current browsing session) is personalized to the user in accordance with the predicted cognitive style of the user.

More specifically, a browsing session refers to a duration of time during which a user is browsing through data, such as browsing one or more webpages on one or more websites. In one or more implementations, a browsing session refers to the time between a web browser being launched and the web browser being terminated. Additionally or alternatively, the browsing session refers to different time spans. For example, a browsing session begins in response to the web browser being launched or a navigation request received after a threshold amount of time of inactivity (e.g., a threshold amount of time with no user input to the web browser). By way of another example, the browsing session ends in response to the web browser being terminated or, after the browsing session has begun, after a threshold amount of time of inactivity (e.g., a threshold amount of time with no user input to the web browser).

Although reference is made herein to the browsing session being a web browsing session in which a user is browsing different webpages on one or more websites, additionally or alternatively the browsing session includes browsing content obtained from or located elsewhere than on webpages. Examples of such browsing sessions include browsing through articles stored locally on a computing device in various formats (e.g., PDF (Portable Document Format) files), browsing through contact information (e.g., phone numbers, email addresses) on the computing device, browsing through social media posts or received messages, browsing through a database or other data repository, and so forth.

The digital experience personalization system monitors user interaction with content during a current browsing session in which the user browses one or more webpages, and generates a user interaction information collection describing the interaction of the user with the content on the webpages during the current browsing session. The user interacts with content on a webpage in various different manners, such as clicking on the content, touching the content (e.g., in situations in which content is displayed on a touchscreen), hovering over content (e.g., with a mouse), scrolling through content, user focusing on content with his eyes, and so forth. These interactions are identified in various different manners, such as tracking mouse movements, tracking gesture inputs on a touchscreen (e.g., for scrolling), tracking eye movements of the user, and so forth.

A user interaction with content refers to a user taking an action with respect to content. These action include explicitly acting on the content (e.g., hovering over the content or clicking on the content) and implicitly acting on the content (e.g., focusing on the content with his eyes).

For each user interaction, a timestamp of when the user interaction occurred, what type of user interaction occurred (e.g., clicked on the content, hovered over the content, focused on the content, etc.), and a location on the display device with which the user interacted (e.g., the location that was clicked on, the location that was hovered over, the location that was focused on, etc.) is recorded. Thus, a time series of user interactions indicating the time, type, and location of each interaction is generated.

The content that the user interacted with is also determined given the location on the display device that the user interacted with and the knowledge of what content is displayed at which locations on the display device. For example, on every webpage load, the viewport (the user's visible area of the webpage) and the position coordinates of all the content elements or pieces on the webpage are obtained. The location on the display device that the user interacted with is readily mapped to the content that the user interacted with given this viewport. An amount of time that the user spends on the different content is also determined from this interaction data.

A representation that describes a piece of content that the user interacts with is generated in various manners depending at least in part on the modality of the content. These representations include, for example, a vector representation of text, a vector representation that includes various features of image content, a vector representation that includes various features of video content, a vector representation that includes various features of the GIF content, a vector representation that includes various features of the audio content, and so forth.

For each user interaction, user interaction information is generated and included in a user interaction information collection. In one or more implementations, the user interaction information for a given user interaction includes an indication of the type of user interaction, the representation of the content the user interacted with, the amount of time that the user spent interacting with the content, and the modality of the content that the user interacted with.

A machine learning system analyzes the user interaction information collection and generates a cognitive style prediction, which is a prediction of the cognitive style the user prefers for consuming content. In one or more implementations, the machine learning system includes a feature extractor and a classifier. The feature extractor generates a set of features representing the user interaction information collection. These features are effectively a summary of the user interactions that the user has performed so far in the current browsing session. In response to receiving each user interaction information collection during the current browsing session, the feature extractor generates a new set of features. In one or more implementations, the feature extractor is implemented as a recurrent neural network, such as a Long Short Term Memory (LSTM) network or a Bi-directional Long Short Term Memory (Bi-LSTM) network. The Bi-LSTM learns the sequential information present in the user interaction information collection for a current browsing session.

The classifier receives the features from the feature extractor and generates a cognitive style prediction. The cognitive style prediction is an indication, for each dimension, of the cognitive style of the user for that dimension. In one or more implementations, the indication of the cognitive style for a dimension is simply a name or other value corresponding to that dimension (e.g., a value of “visual” for the visual vs verbal dimension). Additionally or alternatively, the indication of the cognitive style takes different forms, such as confidence score indicating how confident the classifier is in predicting a particular value for a dimension (e.g., a value of 0.85 for the visual vs verbal dimension to indicate that the classifier is 85% confident that the value for the visual vs verbal dimension is “visual”).

The classifier is implemented as one of various types of classifiers, such as a convolutional neural network (CNN). In one or more implementations, the classifier includes three fully connected layers followed by a sigmoid activation. The final fully connected layer includes one hidden unit for each different dimension of cognitive styles (e.g., seven hidden units).

The machine learning system is trained with the feature extractor and classifier being trained together, end-to-end. The machine learning system is trained, for example, by updating weights or values of hidden layers to minimize the loss between known cognitive styles of users and the cognitive style predictions generated by the classifier. The machine learning system is trained using training data that is multiple user interaction information collections for multiple training users. The user interaction information collection for a training user is obtained by having the training user browse through one or more webpages of one or more websites. A known cognitive style is obtained for each training user in various mariners, such as being specified by the training user (e.g., the user explicitly indicates that he prefers visual rather than verbal content), being obtained using questionnaires for tests that indicate cognitive style, and so forth.

At the beginning of training, the weights or values of hidden states of the feature extractor and the classifier are initialized to random or approximately random (e.g., pseudorandom) numbers. These weights or values are then updated during training with the user interaction information collection for each browsing session for each user to minimize the loss (e.g., cross-entropy loss) between the known cognitive style of the user and the cognitive style predictions generated by the classifier.

During operation, after the classifier has been trained, the machine learning system is used to generate a cognitive style prediction for a user for a current browsing session. The weights or values of hidden states of the feature extractor and the classifier are the weights or values determined during training. Each user interaction information collection is provided to the feature extractor and the classifier generates the cognitive style prediction. In response to each user interaction information collection received by the feature extractor, the classifier generates a cognitive style prediction. Accordingly, the cognitive style prediction is able to change over time during the current browsing session as additional user interaction information for the user is obtained.

Personalized content is caused to be generated by modifying content for the user in accordance with the cognitive style prediction for the user. For example, a webpage is received from a website hosting system and the webpage includes different modalities for content on the webpage. E.g., for particular content on the webpage, the webpage includes first content corresponding to an analytic cognitive style and second content corresponding to a holistic cognitive style. The digital experience personalization system displays the webpage including the first content (rather than the second content) in response to a cognitive style prediction of analytic for the user in the current browsing session, and displays the webpage including the second content (rather than the first content) in response to a cognitive style prediction of holistic for the user in the current browsing session.

Additionally or alternatively, the digital experience personalization system causes the personalized content to be generated by communicating with a remote system, such as a website hosting system. For example, for a current browsing session, the digital experience personalization system communicates an indication of the cognitive style prediction for the user. The website hosting system includes different modalities for content on a webpage and selects the modality for content on the webpage the user is browsing based on the cognitive style prediction for the user. E.g., the website hosting system provides to a web browser the webpage including the first content (rather than the second content) in response to a cognitive style prediction of analytic for the user in the current browsing session and provides to the web browser the webpage including the second content (rather than the first content) in response to a cognitive style prediction of holistic for the user in the current browsing session.

Additionally or alternatively, the personalization module causes to be generated personalized content other than webpages. Examples of personalized content other than webpages include email content, social media content, message content (e.g., multimedia messaging service (MMS) content), and so forth.

In one or more implementations the machine learning system is further trained based on the current browsing session. In such situations, the known cognitive style is provided by user feedback indicating whether the cognitive style prediction is accurate. This user feedback is provided in various manners, such as explicitly (e.g., the user providing a yes or no indication as to whether the modality for particular content displayed in the current browsing session was good) or implicitly (e.g., content is displayed in a first modality only to have the user change the modality, such as by navigating to a different webpage). Given the known cognitive style from the user feedback, the training module further trains the machine learning system using the user interaction information collection and the known cognitive style for the current browsing session analogous to the training discussion above.

The techniques discussed herein allow content to be displayed to the user in accordance with an automatically predicted preference for the user. Explicit feedback from the user, such filling out questionnaires that indicate the user's preference, need not be received.

Furthermore, the techniques discussed herein allow content in the modality the user prefers to be automatically displayed or otherwise presented to the user, decreasing the amount of time it takes for the content to be displayed or otherwise presented in the modality preferred by the user. For example, the user need not expend time or resources changing from one modality to another. Similarly, when using a computing device in which it is difficult to switch between modes (e.g., devices with small user interfaces, such as smartwatches, where user inputs are difficult), the techniques discussed allow the modality of the content to be displayed or otherwise presented in the modality preferred by the user without needing user input selecting the modality.

Additionally, the techniques discussed herein adapt to the preferences of the user automatically, such as during a web browsing session. Prior knowledge regarding the preferences of the user is not needed and need not be maintained from one browsing session to the next.

Term Descriptions

These term descriptions are provided for purposes of example only and are not intended to be construed as limiting on the scope of the claims.

The term “digital experience” refers to the manner in which digital content is displayed or otherwise presented to a user. Examples of digital experiences include displaying content in different manners (e.g., as text, image, or video), different wordings of text content, different frequencies of communicating or displaying content to the user, and so forth.

The term “user interaction” refers to a user taking an action with respect to content. Examples of user interactions include clicking on content, hovering over content (e.g., with a mouse), scrolling through content, focusing on content with their eyes, and so forth.

The term “browsing session” refers to a duration of time during which a user is browsing through data, such as browsing one or more webpages on one or more websites. For example, a time between a web browser being launched and the web browser being terminated.

The term “content” refers to displayable or otherwise presentable data. Examples of content include data describing people, places, things, music, and so forth.

The term “modality” of content refers to a type of content. Examples of modalities of content include text, image, video, GIF (Graphics Interchange Format), audio, and so forth.

The term “consuming content” refers to a user taking in or utilizing content. Examples of consuming content include reading text, viewing images or video, listening to audio, and so forth.

The term “cognitive style” or “learning style” refers to a manner in which a user prefers to interact with or process information. Cognitive style is measured along one or more of different dimensions.

The term “dimension” of cognitive style refers to types or categories of cognitive style. A user has a cognitive style that is one of at least two different manners in which the user prefers to interact with or process information. Examples of dimensions of cognitive style include analytic vs holistic, visual vs verbal, impulsive vs deliberative, extraversion vs introversion, sensing vs intuitive, thinking vs feeling, and judging vs perceiving.

In the following discussion, an example environment is first described that employs examples of techniques described herein. Example procedures are also described which are performable in the example environment as well as other environments. Consequently, performance of the example procedures is not limited to the example environment and the example environment is not limited to performance of the example procedures.

Example Environment

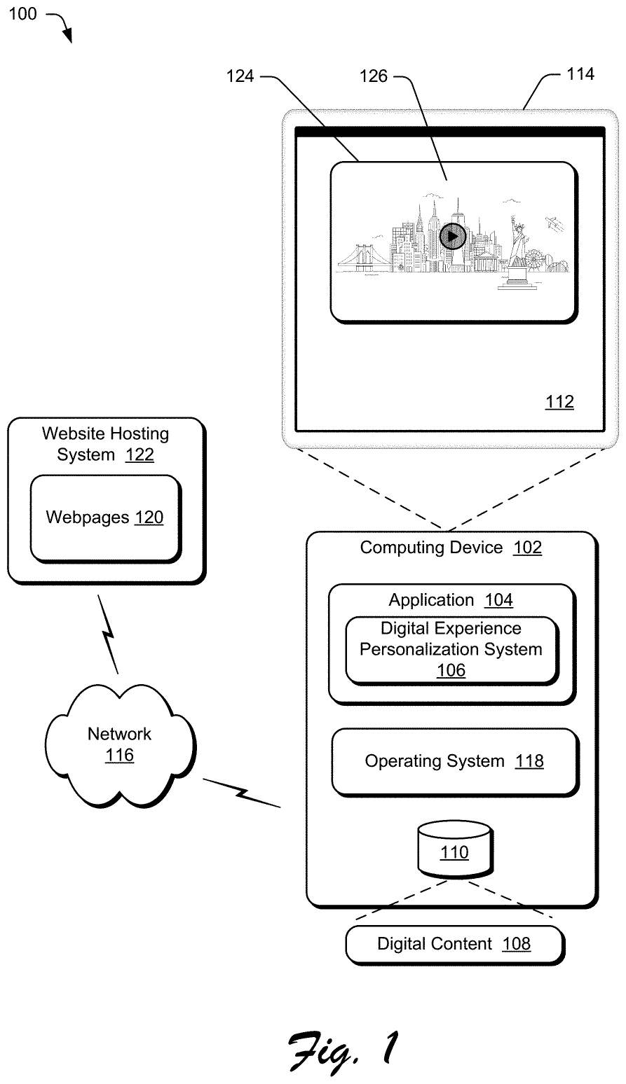

FIG. 1 is an illustration of a digital medium environment 100 in an example implementation that is operable to employ the personalizing digital experiences based on predicted user cognitive style described herein. The illustrated digital medium environment 100 includes a computing device 102, implemented in any of a variety of ways. Examples of the computing device 102 include a mobile device (e.g., assuming a handheld configuration such as a tablet or mobile phone), a wearable device (e.g., augmented reality or virtual reality headsets, smartwatches), a laptop computer, a desktop computer, a game console, an automotive computer, and so forth. Thus, implementations of the computing device 102 range from full resource devices with substantial memory and processor resources (e.g., personal computers, game consoles) to a low-resource device with limited memory and/or processing resources (e.g., mobile devices). Additionally, although a single computing device 102 is shown, additionally or alternatively the computing device is representative of a plurality of different devices, such as multiple servers utilized by a business to perform operations “over the cloud” as described in FIG. 8.

The computing device 102 is illustrated as including an application 104 (e.g., a web browser) that includes a digital experience personalization system 106. The application 104 processes and transforms digital content 108, which is illustrated as maintained in storage 110 of the computing device 102. Such processing includes creation of the digital content 108 and rendering of the digital content 108 in a user interface 112 for output, e.g., by a display device 114. Although illustrated as being displayed, additionally or alternatively the UI is presented in other mariners (e.g., audibly, haptically). The storage 110 is any of a variety of different types of storage, such as random access memory (RAM), Flash memory, solid state drive, magnetic disk drive, and so forth. Although illustrated as implemented locally at the computing device 102, additionally or alternatively functionality of the application 104, including the digital experience personalization system 106, is implemented in whole or part via functionality available via a network 116, such as part of a web service or “in the cloud.”

The computing device 102 also includes an operating system 118 that implements functionality to manage execution of application 104 as well as other applications on the computing device 102, to operate as an interface between the application 104 and hardware of the computing device 102, and so forth.

The digital experience personalization system 106 implements functionality to monitor user interaction with content during a current browsing session in which the user browses webpages 120 on a website hosting system 122. Although a single website hosting system 122 is illustrated, additionally or alternatively the user browses webpages across multiple different website hosting systems. The digital experience personalization system 106 generates user interaction information including a description of the content on the webpages 120 with which the user interacted during the current browsing session, an indication of how long the user interacted with the content, and an indication of the type of the user interaction (e.g., clicking on content, scrolling through content, hovering over content). The digital experience personalization system 106 employs a machine learning system to analyze the user interaction information and generate a prediction of a cognitive style the user prefers for consuming content. Subsequent content (e.g., during the current browsing session) is personalized to the user in accordance with the predicted cognitive style of the user.

For example, the user interface 112 displays a webpage 124 including content 126 that is personalized to a user in response to the digital experience personalization system 106 determining that the cognitive style of the user is holistic rather than analytic. In this example, the webpage 124 includes information describing the Statue of Liberty that includes content personalized to the holistic cognitive style of the user by displaying the content in the video modality (e.g., a video describing the city and statue that is playable by the user or has playback automatically initiated) rather than, for example, a list of facts regarding the city and statue.

The cognitive style of a user refers to a manner in which the prefers to interact with or process information as discussed above. Cognitive style is measured along one or more of different dimensions, such as analytic vs holistic, visual vs verbal, impulsive vs deliberative, extraversion vs introversion, sensing vs intuitive, thinking vs feeling, and judging vs perceiving. For example, a user having a cognitive style that is analytic rather than holistic prefers content in the form of technical details and descriptions, statistics, precise values (e.g., exact dimensions or location coordinates). However, a user having a cognitive style that is holistic rather than analytic prefers content in a more generic or summary form (e.g., a high-level summary of a geographic location rather than the exact dimensions and location coordinates of the geographic location).

By way of another example, a user having a cognitive style of visual rather than verbal prefers content to be displayed in a picturesque form (e.g., images or video) rather than text or audio form. However, a user having a cognitive style of verbal rather than visual prefers content to be displayed in a text or audio form rather than a picturesque form.

In general, functionality, features, and concepts described in relation to the examples above and below are employable in the context of the example systems and procedures described herein. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combined in different ways. Thus, individual functionality, features, and concepts described in relation to different example environments, devices, components, figures, and procedures herein are usable in any suitable combinations and are not limited to the particular combinations represented by the enumerated examples in this description.

Digital Experience Personalization System Architecture

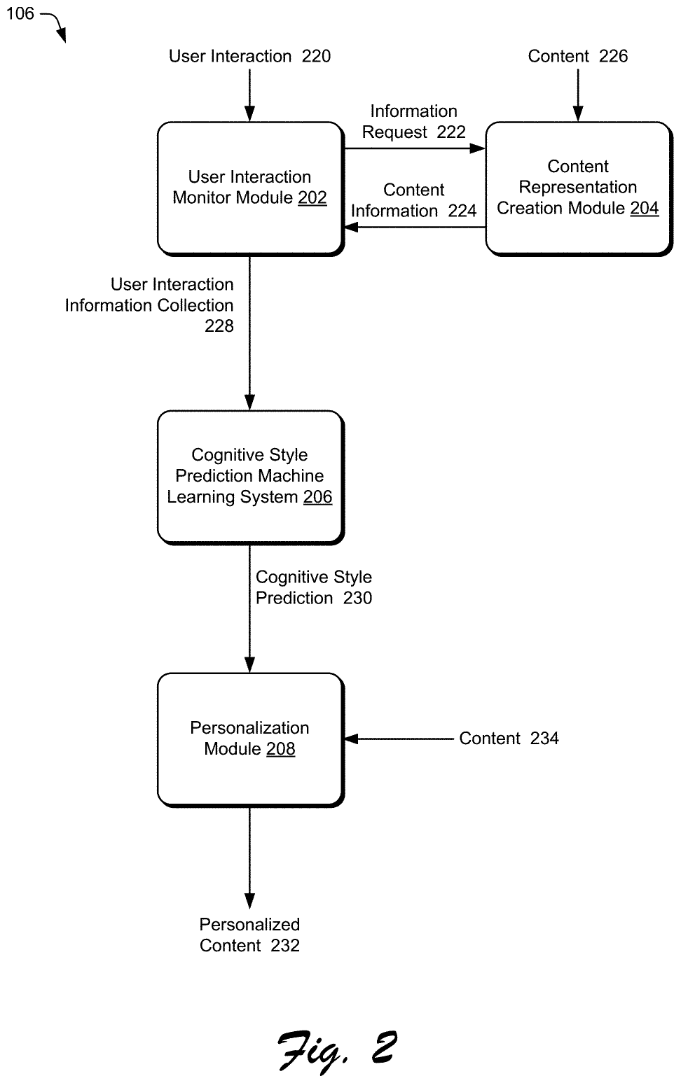

FIG. 2 is an illustration of an example architecture of a digital experience personalization system 106. The digital experience personalization system 106 includes a user interaction monitor module 202, a content representation creation module 204, a cognitive style prediction machine learning system 206 and a personalization module 208.

Generally, the user interaction monitor module 202 monitors user interaction 220 with content during a current browsing session in which the user browses one or more webpages. The user interaction monitor module 202 communicates an information request 222 to the content representation creation module 204, which generates content information 224 describing the content 226 on the webpages with which the user interacted during the current browsing session. The user interaction monitor module 202 generates user interaction information collection 228 indicating which content 226 on the webpages the user interacted with, how long the user interacted with the content 226, and so forth. The cognitive style prediction machine learning system 206 analyzes the user interaction information collection 228 and generates a cognitive style prediction 230 that is a prediction of a cognitive style the user prefers for consuming content. The personalization module 208 generates, or causes to be generated, personalized content 232 from subsequent content 234 (e.g., on a webpage displayed during the current browsing session) by modifying the subsequent content 234 for the user in accordance with the cognitive style prediction 230 for the user.

A browsing session refers to a duration of time during which a user is browsing through data, such as browsing one or more webpages on one or more websites. In one or more implementations, a browsing session refers to the time between a web browser (e.g., application 104) being launched and the web browser being terminated. Additionally or alternatively, the browsing session refers to different time spans. For example, a browsing session begins in response to the web browser being launched or a navigation request received after a threshold amount of time of inactivity (e.g., a threshold amount of time with no user input to the web browser). By way of another example, the browsing session ends in response to the web browser being terminated or, after the browsing session has begun, after a threshold amount of time of inactivity (e.g., a threshold amount of time with no user input to the web browser). E.g., the web browser opens for an extended duration of time (e.g., hours or days) and the browsing session begins in response to a navigation request received after a threshold amount of time of inactivity (e.g., 5 minutes), and continues with at least some user interaction with the web browser, and the browsing session ends after another threshold amount of time of inactivity (e.g., 5 minutes).

Although reference is made herein to the browsing session being a web browsing session in which a user is browsing different webpages on one or more websites, additionally or alternatively the browsing session includes browsing content obtained from or located elsewhere than on webpages. Examples of such browsing sessions include browsing through articles stored locally on the computing device 102 in various formats (e.g., PDF (Portable Document Format) files), browsing through contact information (e.g., phone numbers, email addresses) on the computing device 102, browsing through social media posts or received messages, browsing through a database or other data repository, and so forth.

The user interaction monitor module 202 implements functionality to monitor user interaction 220 with content during a current browsing session in which the user browses one or more webpages, and generates user interaction information collection 228 describing the interaction of the user with the content 226 on the webpages during the current browsing session. The user interacts with content on a webpage in various different manners, such as clicking on the content, touching the content (e.g., in situations in which the display device 114 is a touchscreen), hovering over content (e.g., with a mouse), scrolling through content, focusing on content with his eyes, and so forth. These interactions are identified in various different manners, such as tracking mouse movements, tracking gesture inputs on a touchscreen (e.g., for scrolling), tracking eye movements of the user, and so forth.

A user interaction with content refers to a user taking an action with respect to content. These action include explicitly acting on the content (e.g., hovering over the content or clicking on the content) and implicitly acting on the content (e.g., focusing on the content with his eyes).

For each user interaction, the user interaction monitor module 202 records a timestamp of when the user interaction occurred, what type of user interaction occurred (e.g., clicked on the content, hovered over the content, focused on the content, etc.), and a location on the display device 114 with which the user interacted (e.g., the location that was clicked on, the location that was hovered over, the location that was focused on, etc.). Thus, the user interaction monitor module 202 generates a time series of user interactions indicating the time, type, and location of each interaction. The data for these interactions provides information about what the user is interested in at various times along with how he is interacting with the content on the webpage.

The user interaction monitor module 202 determines the content that the user interacted with. This determination is readily made given the location on the display device 114 that the user interacted with, and the knowledge of what content is displayed at which locations on the display device 114 (e.g., as obtained from the application 104 or the operating system 118). For example, on every webpage load, the user interaction monitor module 202 obtains the viewport (the user's visible area of the webpage) and the position coordinates of all the content elements or pieces on the webpage. The location on the display device 114 that the user interacted with is readily mapped to the content that the user interacted with given this viewport.

The user interaction monitor module 202 also determines an amount of time that the user spends on the different content from this interaction data. For example, assume that a webpage includes four pieces of content: one piece of image content, one piece of video content, and two pieces of text content. When the user begins focusing on the image content, the user interaction monitor module 202 records the data for the interaction. At a subsequent time, in response to the focus of the user moving to a location where the image content is not displayed, the user interaction monitor module 202 records the data for another interaction. The difference between the timestamps in the data for these two interactions is the amount of time the user spent interacting with the image content.

For content that the user interacts with, the user interaction monitor module 202 communicates an information request 222 to the content representation creation module 204. Additionally or alternatively, the user interaction monitor module 202 communicates an information request 222 to the content representation creation module 204 for each piece of content on the webpage. The content representation creation module 204 implements functionality to generate content information 224 describing the content 226 indicated in the information request 222.

The content representation creation module 204 generates a representation that describes a piece of content in various manners depending at least in part on the modality of the content. In one or more implementations, the content representation creation module 204 generates a representation of text content by generating a vector representation of the text. Any of a variety of public or proprietary techniques for generating a vector representation of text are usable by the content representation creation module 204. One such technique is discussed in “GloVe: Global Vectors for Word Representation,” by Jeffrey Pennington, Richard Socher, and Christopher D. Manning, Proceedings of the 2014 Conference on Empirical Methods in Natural Language Processing (EMNLP), pages 1532-1543, Oct. 25-29, 2014.

In one or more implementations, the content representation creation module 204 generates a representation of image content by generating a vector representation that includes various features of the image content. Any of a variety of public or proprietary techniques for generating a vector representation of an image are usable by the content representation creation module 204. One such technique is using a deep residual learning model, such as a ResNet model pretrained on the ImageNet dataset. Details of the ImageNet dataset are found in “ImageNet large scale visual recognition challenge,” by 0. Russakovsky, J. Deng, H. Su, J. Krause, S. Satheesh, S. Ma, Z. Huang, A. Karpathy, A. Khosla, M. Bernstein, et al., arXiv:1409.0575, 2014. A discussion of deep residual learning is found in “Deep Residual Learning for Image Recognition,” by Kaiming He, Xiangyu Zhang, Shaoqing Ren, and Jian Sun, IEEE Conference on Computer Vision and Pattern Recognition (CVPR), 2016.

In one or more implementations, the content representation creation module 204 generates a representation of video content by generating a vector representation that includes various features of the video content. Any of a variety of public or proprietary techniques for generating a vector representation of video are usable by the content representation creation module 204. One such technique is to generate, for each frame of the video content, a representation of the frame in the same manner as discussed above regarding generating a vector representation that includes various features of image content. These representations (e.g., vectors) are averaged to generate the representation of the video content.

In one or more implementations, the content representation creation module 204 generates a representation of GIF content by generating a vector representation that includes various features of the GIF content. Any of a variety of public or proprietary techniques for generating a vector representation of a GIF are usable by the content representation creation module 204. One such technique is to treat the GIF content as video and generate a representation of the GIF content analogously to the generation of video content discussed above, and including an additional identifier in the representation (e.g., a single bit) indicating that the content is GIF content.

In one or more implementations, the content representation creation module 204 generates a representation of audio content by generating a vector representation that includes various features of the audio content. Any of a variety of public or proprietary techniques for generating a vector representation of audio are usable by the content representation creation module 204. One such technique is to calculate, for each of multiple windows of the audio (e.g., 5 second durations of the audio) a Mel Frequency Cepstral Coefficient (MFCC) that is an indication of which frequencies are present in the window.

In one or more implementations, the content representation creation module 204 generates representations of content with models trained across a wide range of data sources, such as many different webpages from many different websites. Additionally or alternatively, the content representation creation module 204 uses models to generate representations of content that are trained for or target particular data sources. For example, content representation creation module 204 uses models to generate representations of content that are trained across webpages from a particular one or more websites. These are trained, for example, along with the training of the cognitive style prediction machine learning system 206 discussed in more detail below, resulting in different models (with different weight or values for hidden layers) for different websites.

For each interaction, user interaction information is generated and included in a user interaction information collection 228. In one or more implementations, the user interaction information for a given user interaction includes an indication of the type of user interaction, the representation of the content the user interacted with, the amount of time that the user spent interacting with the content, and the modality of the content that the user interacted with.

The user interaction monitor module 202 provides the user interaction information collection 228 to the cognitive style prediction machine learning system 206. The cognitive style prediction machine learning system 206 analyzes the user interaction information collection 228 and generates the cognitive style prediction 230, which is a prediction of the cognitive style the user prefers for consuming content.

In one or more implementations, the user interaction monitor module 202 generates user interaction information for each user interaction as discussed above, collecting the user interaction information and waiting until user interaction information has been generated for a particular number of user interactions. Once user interaction information has been generated for the particular number of user interactions, user interaction monitor module 202 provides the user interaction information collection 228 to the personalization module 208.

The particular number of user interactions for which user interaction information is included in the user interaction information collection 228 varies, such as ranging from 10 to 20. The particular number of user interactions is selected based on various criteria, such as empirically for a particular website (or webpage) based on different numbers of user interactions and performance of the digital experience personalization system 106 for those different numbers of user interactions.

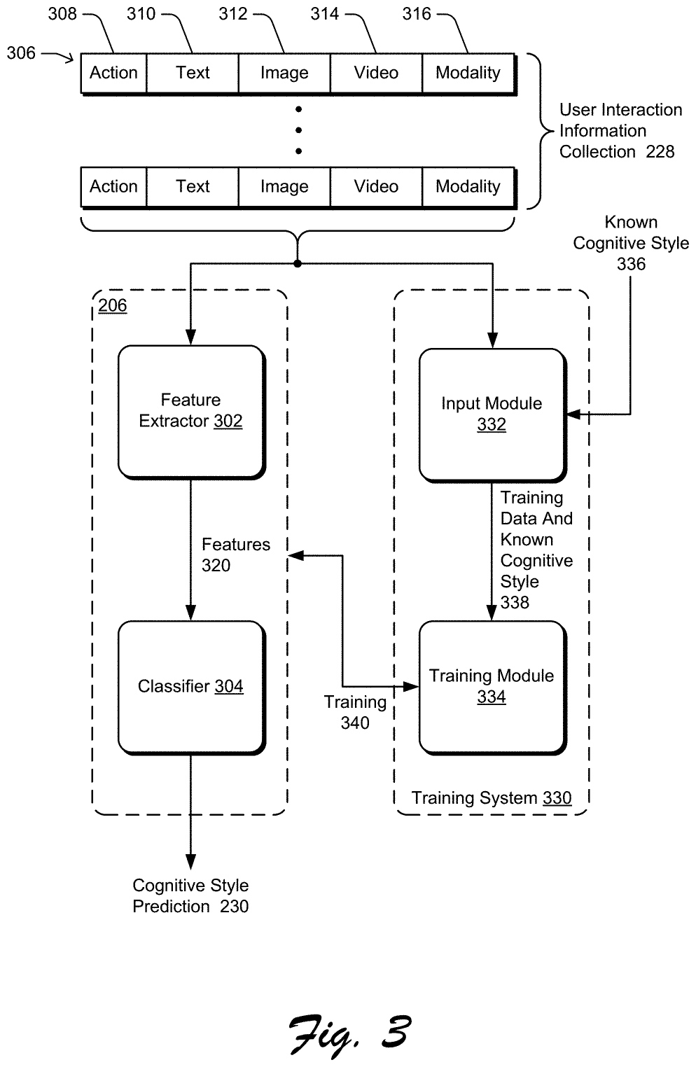

FIG. 3 is an illustration of an example architecture of cognitive style prediction machine learning system 206. The cognitive style prediction machine learning system 206 includes a feature extractor 302 and a classifier 304. The user interaction information collection 228 is input to the feature extractor 302. In the illustrated example, user interaction information collection 228 includes multiple user interaction information each in the form of a vector. A user interaction information vector 306 is illustrated as an example including user interaction information for a given user interaction, the user interaction information vector 306 including (e.g., a concatenation of) action information 308, text information 310, image information 312, video information 314, and modality information 316.

Although illustrated as including text information 310, image information 312, and video information 314, additionally or alternatively a user interaction information vector 306 includes different information. For example, in some situations video information 314 is not included in user interaction information vector 306, such as if the video modality is not of interest to a designer or user of cognitive style prediction machine learning system 206. By way of another example, audio information is included in user interaction information vector 306 if audio modality is of interest to a designer or user of cognitive style prediction machine learning system 206.

The action information 308 describes the type of user interaction for the user interaction information vector 306. In one or more implementations, the action information 308 includes a one hot vector including one element for each possible type of user interaction and the element corresponding to the type of user interaction for the user interaction information vector 306 being set to a particular value (e.g., 1) and the other elements being set to a different value (e.g., 0). The action information 308 also includes an element that is the amount of time (e.g., in seconds or some other unit) that the user spent interacting with the content for the user interaction represented by the user interaction information vector 306.

The text information 310, image information 312, and video information 314 are each a content representation generated by content representation creation module 204 as discussed above. In one or more implementations, for each user interaction information vector 306, one of the text information 310, image information 312, and video information 314 have the content representation generated by content representation creation module 204 and the other two of the text information 310, image information 312, and video information 314 have default values (e.g., all zeroes). For example, if the user interacted with text content for the user interaction represented by the user interaction information vector 306, the text information 310 has the content representation generated by content representation creation module 204, while the image information 312 and the video information 314 are all zeroes.

The modality information 316 describes the content modality for the user interaction information vector 306. In one or more implementations, the modality information 316 is a one hot vector including one element for each possible type of content modality and the element corresponding to the modality of the content for the user interaction information vector 306 being set to a particular value (e.g., 1) and the other elements being set to a different value (e.g., 0). The modality information 316 is obtained in various manners, such as from metadata of the content, html or other identifying tags of the content, and so forth.

In one or more implementations, the feature extractor 302 and the classifier 304 are each a machine learning system. Machine learning systems refer to a computer representation that is tuned (e.g., trained) based on inputs to approximate unknown functions. In particular, machine learning systems are systems that utilize algorithms to learn from, and make predictions on, known data by analyzing the known data to learn to generate outputs that reflect patterns and attributes of the known data. For instance, machine learning systems include decision trees, support vector machines, linear regression, logistic regression, Bayesian networks, random forest learning, dimensionality reduction algorithms, boosting algorithms, artificial neural networks, deep learning, and so forth.

The feature extractor 302 receives the user interaction information collection 228 with the individual user interaction information in the user interaction information collection 228 being input to the feature extractor 302 one transaction at a time. For example, if a user interaction information collection 228 includes user interaction information for ten user interactions, the user interaction information from the user interaction information collection 228 is fed into the feature extractor 302 in a series from earliest of the ten user interactions to latest of the ten user interactions.

The feature extractor 302 generates a set of features 320 representing the user interaction information collection 228. These features 320 are effectively a summary of the user interactions that the user has performed so far in the current browsing session. In response to receiving each user interaction information collection 228 during the current browsing session, the feature extractor 302 generates a new set of features 320. In one or more implementations, the feature extractor 302 is implemented as a recurrent neural network, such as a Long Short Term Memory (LSTM) network or a Bi-directional Long Short Term Memory (Bi-LSTM) network. Additionally or alternatively, the feature extractor 302 is implementable as other types of machine learning systems. The Bi-LSTM learns the sequential information present in the user interaction information collection 228 for a current browsing session.

The classifier 304 receives the features 320 and generates a cognitive style prediction 230. The cognitive style prediction 230 is an indication, for each dimension, of the cognitive style of the user for that dimension. In one or more implementations, the indication of the cognitive style for a dimension is simply a name or other value corresponding to that dimension (e.g., a value of “visual” for the visual vs verbal dimension). Additionally or alternatively, the indication of the cognitive style takes different forms, such as a confidence score indicating how confident the classifier 304 is in predicting a particular value for a dimension (e.g., a value of 0.85 for the visual vs verbal dimension to indicate that the classifier 304 is 85% confident that the value for the visual vs verbal dimension is “visual”).

The classifier 304 is implemented as one of various types of classifiers, such as a convolutional neural network (CNN). A CNN is formed from layers of nodes (i.e., neurons) and includes various layers such as an input layer, an output layer, and one or more hidden layers such as convolutional layers, pooling layers, activation layers, fully connected layers, normalization layers, and so forth. In one or more implementations, the classifier 304 includes three fully connected layers followed by a sigmoid activation. The final fully connected layer includes one hidden unit for each different dimension of cognitive styles (e.g., seven hidden units).

In one or more implementations, the digital experience personalization system 106 includes a training system 330 as illustrated in FIG. 3. The training system 330 is optional and is usable to initially train the cognitive style prediction machine learning system 206. Additionally or alternatively, the training system 330 is trained by another device or system and retrieved by the digital experience personalization system 106. The training system 330 is also usable to further train the cognitive style prediction machine learning system 206 as a user is browsing webpages. The training system 330 trains the cognitive style prediction machine learning system 206, training the feature extractor 302 and classifier 304 together, end-to-end. The cognitive style prediction machine learning system 206 is trained, for example, by updating weights or values of hidden layers to minimize the loss between known cognitive styles of users and the cognitive style predictions generated by the classifier 304.

The training system 330 includes an input module 332 and a training module 334. The input module 332 receives training data used to train the cognitive style prediction machine learning system 206, the training data being, for each of multiple users (referred to as training users), a user interaction information collection 228. The user interaction information collection 228 for a training user is obtained by having the training user browse through one or more webpages of one or more websites. A known cognitive style 336 is obtained for each training user in various mariners, such as being specified by the training user (e.g., the user explicitly indicates that he prefers visual rather than verbal content), being obtained using questionnaires for tests that indicate cognitive style, and so forth. Examples of such questionnaires include a Felder-Solomon test, a Behavioral Inhibition System test, a Cognitive Skills Index, and so forth. The training data and known cognitive style obtained by the input module 332 are provided to the training module 334 as training data and known cognitive style 338 and are used by the training module 334 to perform the training 340 of the cognitive style prediction machine learning system 206.

At the beginning of training, the weights or values of hidden states of the feature extractor 302 and the classifier 304 are initialized to random or approximately random (e.g., pseudorandom) numbers. These weights or values are then updated during training with the user interaction information collection 228 for each browsing session for each user to minimize the loss (e.g., cross-entropy loss) between the known cognitive style of the user and the cognitive style predictions generated by the classifier 304.

In one or more implementations, the training 340 is terminated when the loss converges to a near zero constant value. Additionally or alternatively, the training 340 terminates in response to other events, such as a threshold time duration expiring, a threshold amount training data having been used for training, and so forth.

During operation, after the classifier 304 has been trained, the cognitive style prediction machine learning system 206 is used to generate a cognitive style prediction 230 for a user for a current browsing session. The weights or values of hidden states of the feature extractor 302 and the classifier 304 are the weights or values determined during training. Each user interaction information collection 228 is provided to the feature extractor 302 and the classifier 304 generates the cognitive style prediction 230. In response to each user interaction information collection 228 received by the feature extractor 302, the classifier 304 generates a cognitive style prediction 230. Accordingly, the cognitive style prediction 230 is able to change over time during the current browsing session as additional user interaction information for the user is obtained.

Returning to FIG. 2, the cognitive style prediction 230 is provided to personalization module 208. The personalization module 208 implements functionality to generate, or cause to be generated, personalized content 232 from content 234 by modifying the content 234 for the user in accordance with the cognitive style prediction 230 for the user.

In one or more implementations, the personalization module 208 causes the personalized content 232 to be generated by itself generating the personalized content 232. For example, the application 104 receives a webpage from website hosting system 122 and the webpage includes different modalities for content on the webpage. E.g., for particular content on the webpage, the webpage includes first content corresponding to an analytic cognitive style and second content corresponding to a holistic cognitive style. The personalization module 208 displays the webpage including the first content (rather than the second content) in response to a cognitive style prediction 230 of analytic for the user in the current browsing session, and displays the webpage including the second content (rather than the first content) in response to a cognitive style prediction 230 of holistic for the user in the current browsing session.

Additionally or alternatively, the personalization module 208 causes the personalized content 232 to be generated by communicating with a remote system, such as website hosting system 122. For example, for a current browsing session, the cognitive style prediction machine learning system 206 communicates an indication of the cognitive style prediction 230 for the user. The website hosting system 122 includes different modalities for content on a webpage and selects the modality for content on the webpage the user is browsing based on the cognitive style prediction 230 for the user. E.g., the website hosting system 122 provides to the application 104 the webpage including the first content (rather than the second content) in response to a cognitive style prediction 230 of analytic for the user in the current browsing session and provides to the application 104 the webpage including the second content (rather than the first content) in response to a cognitive style prediction 230 of holistic for the user in the current browsing session.

Additionally or alternatively, the personalization module 208 generates, or causes to be generated, personalized content 232 other than webpages. Examples of personalized content 232 other than webpages include email content, social media content, message content (e.g., multimedia messaging service (MMS) content), and so forth. In one or more implementations, the application 104 receives multiple modalities for particular content from another device (e.g., an email server, a social media server, a messaging service) that include different modalities for the content and displays or otherwise presents the appropriate modality of content based on the cognitive style prediction 230 for the user. Additionally or alternatively, the personalization module 208 communicates an indication of the cognitive style prediction 230 for the user to another device (e.g., an email server, a social media server, a messaging service), causing the other device to and select the modality for content communicated to the application 104 (e.g., email content, social media content, message content) based on the cognitive style prediction 230 for the user.

In one or more implementations, the cognitive style prediction 230 is generated on a browsing session by browsing session basis. Accordingly, at the beginning of a browsing session, the cognitive style prediction machine learning system 206 includes the feature extractor 302 and classifier 304 trained as discussed above. Thus, the cognitive style prediction machine learning system 206 is able to generate a cognitive style prediction 230 for a user the first time he uses the application 104, determining the cognitive style prediction 230 based on the user interaction in the current browsing session.

Furthermore, in one or more implementations the training system 330 further trains the cognitive style prediction machine learning system 206 based on the current browsing session. In such situations, the known cognitive style 336 is provided by user feedback indicating whether the cognitive style prediction 230 is accurate. This user feedback is provided in various manners, such as explicitly (e.g., the user providing a yes or no indication as to whether the modality for particular content displayed in the current browsing session was good) or implicitly (e.g., content is displayed in a first modality only to have the user change the modality, such as by navigating to a different webpage). Given the known cognitive style from the user feedback, the training module 334 further trains the cognitive style prediction machine learning system 206 using the user interaction information collection 228 and the known cognitive style 336 for the current browsing session analogous to the training discussion above. The weights or values of hidden states of the feature extractor 302 and classifier 304 resulting from this further training are maintained from one browsing session to the next. Thus, in such situations the cognitive style prediction machine learning system 206 is able to learn the cognitive style of the user across multiple browsing sessions.

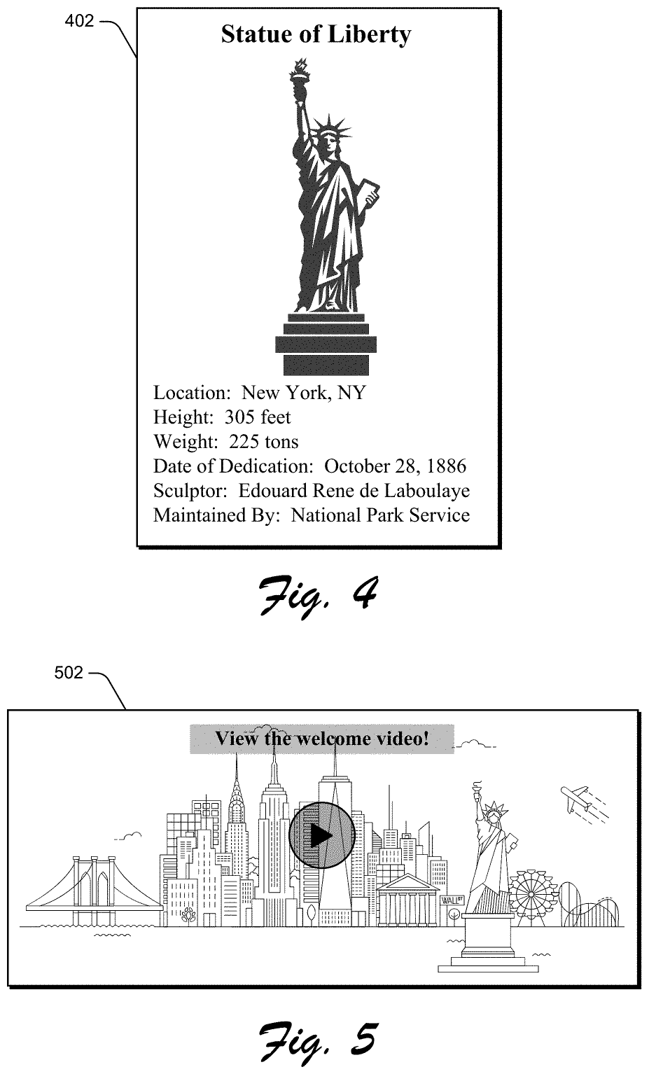

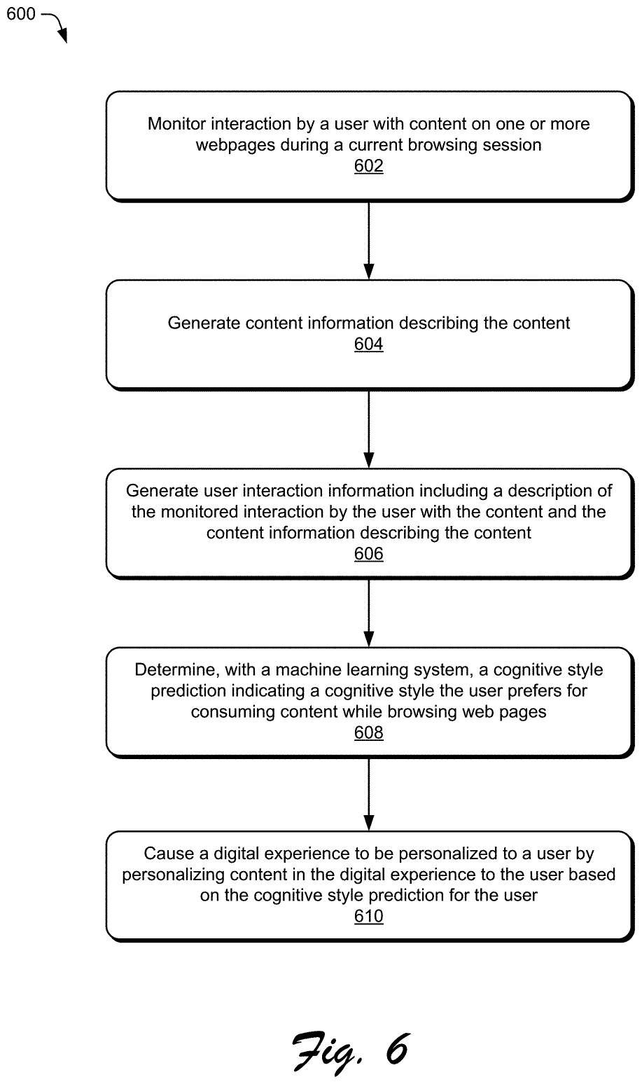

FIGS. 4 and 5 illustrate example uses of the digital experience personalization system 106. FIG. 4 illustrates content 402 that is personalized to a user in response to the digital experience personalization system 106 determining that the cognitive style of the user is analytic rather than holistic. The content 402 is displayed, for example, in a user interface on a display device 114. As illustrated, the content 402 is a list of facts regarding the Statue of Liberty (e.g., height of 305 feet, weight of 225 tons), which is expected to be preferred by a user with the cognitive style of analytic.

FIG. 5 illustrates content that is personalized to a user in response to the digital experience personalization system 106 determining that the cognitive style of the user is holistic rather than analytic. The content 502 is displayed, for example, in a user interface on a display device 114. As illustrated, the content 502 is a video describing the city and statue that is playable by the user or has playback automatically initiated, which is expected to be preferred by a user with the cognitive style of analytic.

Returning to FIG. 2, in one or more implementations each cognitive style prediction 230 that is generated is by the cognitive style prediction machine learning system 206 is provided to one or more other systems or modules for various uses. For example, the cognitive style prediction 230 is displayed on a user interface (e.g., user interface 112). Additional information from the user interaction information collection 228 for the browsing session, such as the modalities corresponding to the cognitive style prediction 230, are also optionally provided. These modalities are, for example, pre-configured in the digital experience personalization system 106, obtained from other sources (e.g., a system via network 116), and so forth. This cognitive style and other information from the user interaction information collection 228 is optionally communicated anonymized so that the website hosting system 122 has no knowledge of which user the information corresponds to.

Providing the cognitive style prediction 230, and optionally corresponding modalities, allows various additional modifications of content to be performed. For example, a website designer uses this information to determine which cognitive style users that browse the website have most frequently or least frequency, allowing the website designer to further obtain or create additional content in a modality corresponding to the cognitive style that users have most frequently and obtain or create less content in a modality corresponding to the cognitive style that users have least frequently. This allows resources (e.g., computing resources used in creating content, time spent in creating content) to be allocated on obtaining or creating content in a modality most likely to be used by users browsing the website.

Example Procedures

The following discussion describes techniques that are implemented utilizing the previously described systems and devices. Aspects of the procedure are implemented in hardware, firmware, software, or a combination thereof. The procedure is shown as a set of blocks that specify operations performed by one or more devices and are not necessarily limited to the orders shown for performing the operations by the respective blocks. Furthermore, although various operations performed by one or more devices are recited, the techniques discussed herein additionally or alternatively include additional operations. In portions of the following discussion, reference is made to FIGS. 1-5.

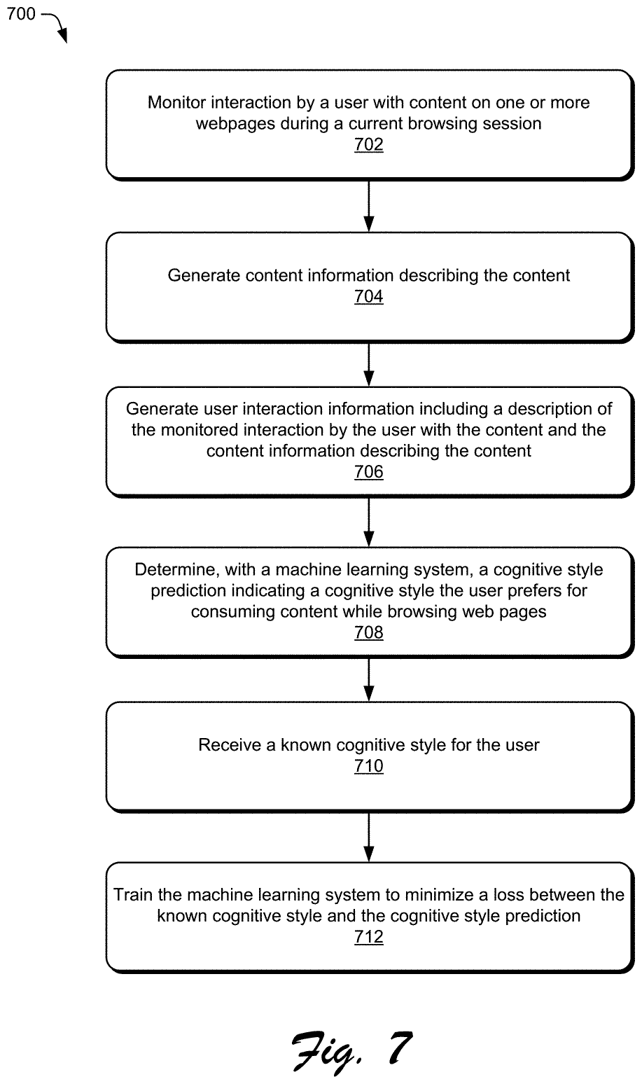

FIG. 6 is a flow diagram 600 depicting a procedure in an example implementation of personalizing digital experiences based on predicted user cognitive style. In this example, interaction by a user with content on one or more webpages during a current browsing session is monitored (block 602). These interactions include, for example, clicking on content, hovering over content (e.g., with a mouse), scrolling through content, focusing on content with their eyes, and so forth.

Content information describing the content is generated (block 604). The content information is generated in various manners based on the modality of the content, such as whether the modality is text, video, image, GIF, audio, and so forth.

User interaction information including a description of the monitored interaction by the user with the content and the content information describing the content is generated (block 606). This user interaction information is, for example, a vector that is a concatenation of the description of the monitored interaction, the content information for each of multiple modalities, and an indication of the modality of the content.

A cognitive style prediction indicating a cognitive style that the user prefers for consuming content while browsing webpages is determined (block 608). This determination is made, for example, by a machine learning system extracting features from both the user interaction information and the content information, and classifying the extracted features to generate the cognitive style prediction for one or more of multiple dimensions.

A digital experience is caused to be personalized to a user by personalizing content in the digital experience to the user based on the cognitive style prediction (block 610). This personalization includes, for example, displaying or otherwise presenting content to the user in different modalities based on the cognitive style prediction for the user.

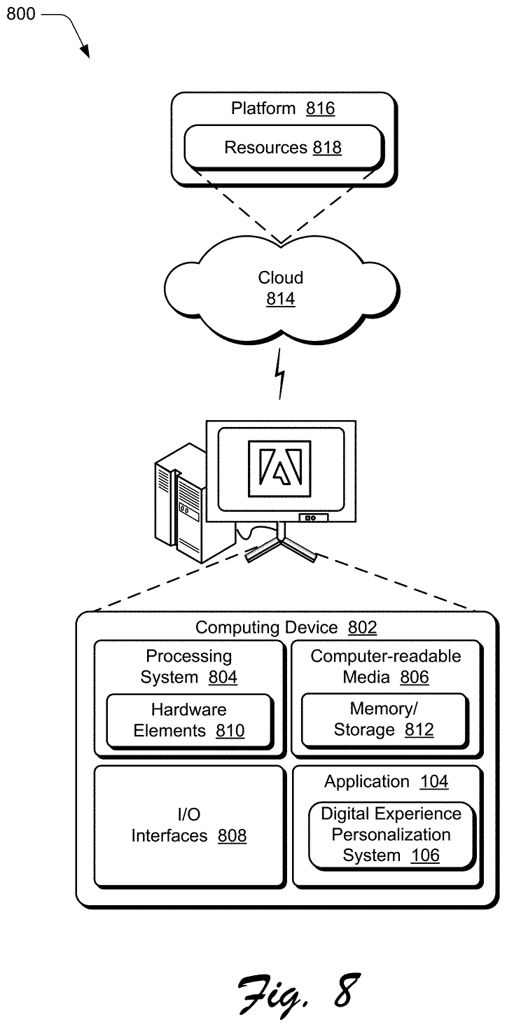

FIG. 7 is a flow diagram 700 depicting a procedure in an example implementation of personalizing digital experiences based on predicted user cognitive style. In this example, interaction by a user with content on one or more webpages during a current browsing session is monitored (block 702). These interactions include, for example, clicking on content, hovering over content (e.g., with a mouse), scrolling through content, focusing on content with their eyes, and so forth.

Content information describing the content is generated (block 704). The content information is generated in various manners based on the modality of the content, such as whether the modality is text, video, image, GIF, audio, and so forth.

User interaction information including a description of the monitored interaction by the user with the content and the content information describing the content is generated (block 706). This user interaction information is, for example, a vector that is a concatenation of the description of the monitored interaction, the content information for each of multiple modalities, and an indication of the modality of the content.

A cognitive style prediction indicating a cognitive style that the user prefers for consuming content while browsing webpages is determined (block 708). This determination is made, for example, by a machine learning system extracting features from both the user interaction information and the content information, and classifying the extracted features to generate the cognitive style prediction for one or more of multiple dimensions.

A known cognitive style for the user is received (block 710). This known cognitive style is received, for example, as user feedback.

The machine learning system is trained based on the known cognitive style for the user (block 712). This training includes, for example, comparing the cognitive style prediction to the known cognitive style for the user, and updating weights or values of hidden states of the machine learning system to minimize a loss between the cognitive style prediction and the known cognitive style for the training user.

Example System and Device

FIG. 8 illustrates an example system generally at 800 that includes an example computing device 802 that is representative of one or more computing systems and/or devices that implement the various techniques described herein. This is illustrated through inclusion of the application 104 with the digital experience personalization system 106. The computing device 802 is, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, in one or more implementations the computing device 802 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that are configured, for example, as processors, functional blocks, and so forth. The processing system 804 is optionally implemented in hardware as an application specific integrated circuit or other logic device formed using one or more semiconductors. The hardware elements 810 are not limited by the materials from which they are formed, or the processing mechanisms employed therein. For example, in one or more implementations processors are comprised of semiconductor(s) and/or transistors (e.g., electronic integrated circuits (ICs)). In such a context, processor-executable instructions include electronically-executable instructions.

The computer-readable storage media 806 is illustrated as including memory/storage 812. The memory/storage 812 represents memory/storage capacity associated with one or more computer-readable media. The memory/storage 812 represents memory/storage capacity associated with one or more computer-readable media. The memory/storage 812 includes one or both of volatile media (such as random access memory (RAM)) and nonvolatile media (such as read only memory (ROM), Flash memory, optical disks, magnetic disks, and so forth). The memory/storage 812 includes one or both of fixed media (e.g., RAM, ROM, a fixed hard drive, and so on) and removable media (e.g., Flash memory, a removable hard drive, an optical disc, and so forth). The computer-readable media 806 is optionally configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

An implementation of the described modules and techniques is optionally stored on or transmitted across some form of computer-readable media. The computer-readable media includes any of a variety of media that is accessible by the computing device 802. By way of example, and not limitation, computer-readable media includes “computer-readable storage media” and “computer-readable signal media.”

“Computer-readable storage media” refers to media and/or devices that enable persistent and/or non-transitory storage of information thereon in contrast to mere signal transmission, carrier waves, or signals per se. Computer-readable storage media is non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which is accessed by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some implementations to implement at least some aspects of the techniques described herein, such as to perform one or more instructions. Hardware includes, for example, components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are optionally employed to implement various techniques described herein. Accordingly, in one or more implementations software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achievable at least partially in hardware, e.g., through use of computer-readable storage media and/or hardware elements 810 of the processing system 804. The instructions and/or functions executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. Additionally or alternatively, this functionality is implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data utilizable while computer processing is executed on servers that are remote from the computing device 802. Resources 818 optionally include services provided over the Internet and/or through a subscriber network, such as a cellular or Wi-Fi network.

The platform 816 abstract resources and functions to connect the computing device 802 with other computing devices. The platform 816 also optionally serves to abstract scaling of resources to provide a corresponding level of scale to encountered demand for the resources 818 that are implemented via the platform 816. Accordingly, in an interconnected device embodiment, implementation of functionality described herein is distributed throughout the system 800. For example, the functionality is implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment, a method implemented by at least one computing device, the method comprising:
monitoring, by a user interaction monitoring module, interaction by a user with content on one or more web pages during a current browsing session;
generating, by a content representation creation module, content information describing the content;
generating, by the user interaction monitoring module, user interaction information including a description of the monitored interaction by the user with the content and the content information describing the content;
determining, by a machine learning system, a cognitive style prediction indicating a cognitive style preferred by the user for consuming content while browsing web pages by extracting features from both the user interaction information and the content information, and classifying the extracted features to generate the cognitive style prediction for one or more of multiple dimensions; and
causing, by a digital experience personalization module, a digital experience to be personalized to a user by personalizing content in the digital experience to the user based on the cognitive style prediction for the user.

2. The method as recited in claim 1, the interaction including clicking on content, hovering over content, or scrolling through content.

3. The method as recited in claim 1, the interaction including user eye focus on content.

4. The method as recited in claim 1, further comprising:
generating a first user interaction information collection including user interaction information for a first set of multiple interactions during the current browsing session;
providing the first user interaction information collection to the machine learning system to generate a first cognitive style prediction for the one or more of multiple dimensions;
generating a second user interaction information collection including user interaction information for a second set of multiple interactions during the current browsing session; and
providing the second user interaction information collection to the machine learning system to generate a second cognitive style prediction for the one or more of multiple dimensions, the first cognitive style prediction being different than the second cognitive style prediction.

5. The method as recited in claim 1, the user interaction information for a user interaction including:
an indication of a type of the user interaction;
a representation of the content; and
an indication of a modality of the content.

6. The method as recited in claim 1, the machine learning system including a Bi-LSTM to extract features from both the user interaction information and the content information.

7. The method as recited in claim 6, further comprising using, for the current browsing session, weights or values of hidden states of the Bi-LSTM determined during a previous browsing session.

8. The method as recited in claim 6, the machine learning system including multiple fully connected layers followed by a sigmoid activation to classify the extracted features to generate the cognitive style prediction for the one or more of multiple dimensions.

9. The method as recited in claim 1, the multiple dimensions, including two or more of: analytic vs holistic, visual vs verbal, impulsive vs deliberative, extraversion vs introversion, sensing vs intuitive, thinking vs feeling, and judging vs perceiving.

10. The method as recited in claim 1, the machine learning system having been trained by providing training data to the machine learning system for a training user, comparing the cognitive style prediction for the training data to a known cognitive style for the training user, and updating weights or values of hidden states of the machine learning system to minimize a loss between the cognitive style prediction for the training data and the known cognitive style for the training user.

11. In digital medium environment, a computing device comprising:
a processor; and
computer-readable storage media having stored thereon multiple instructions that, responsive to execution by the processor, cause the processor to perform operations including:
monitoring, by a user interaction monitoring module, interaction by a user with content on one or more web pages during a current browsing session;
generating, by a content representation creation module, content information describing the content;
generating, by the user interaction monitoring module, user interaction information including a description of the monitored interaction by the user with the content and the content information describing the content;
determining, by a machine learning system, a cognitive style prediction indicating a cognitive style preferred by the user for consuming content by extracting features from both the user interaction information and the content information, and classifying the extracted features to generate the cognitive style prediction for one or more of multiple dimensions;
receiving, by a user feedback module, a known cognitive style for the user; and
training, by a training module, the machine learning system by updating weights or values of hidden states of the machine learning system to minimize a loss between the cognitive style prediction and the known cognitive style for the training user.

12. The computing device as recited in claim 11, the interaction including clicking on content, hovering over content, or scrolling through content.

13. The computing device as recited in claim 11, the operations further comprising causing, by a digital experience personalization module, content to be personalized to the user based on the cognitive style prediction for the user.

14. The computing device as recited in claim 11, the user interaction information for a user interaction including:
an indication of a type of the user interaction;
a representation of the content; and
an indication of a modality of the content.

15. The computing device as recited in claim 11, the machine learning system including a Bi-LSTM to extract features from both the user interaction information and the content information.

16. The computing device as recited in claim 15, the machine learning system including multiple fully connected layers followed by a sigmoid activation to classify the extracted features to generate the cognitive style prediction for the one or more of multiple dimensions.

17. The computing device as recited in claim 15, the multiple dimensions, including two or more of: analytic vs holistic, visual vs verbal, impulsive vs deliberative, extraversion vs introversion, sensing vs intuitive, thinking vs feeling, and judging vs perceiving.

18. A system comprising:
a user interaction monitoring module, implemented at least in part in hardware, to monitor interaction by a user with content on one or more web pages during a current browsing session;
a content representation creation module, implemented at least in part in hardware, to generate content information describing the content;
the user interaction monitoring module being further to generate user interaction information including a description of the monitored interaction by the user with the content and the content information describing the content;
means for determining, based on the user interaction information, a cognitive style prediction indicating a cognitive style preferred by the user for consuming content; and
a digital experience personalization module, implemented at least in part in hardware, to cause content to be personalized to the user based on the cognitive style prediction for the user.

19. The system as recited in claim 18, the means for determining including a machine learning system having been trained by providing training data to the machine learning system for a training user, comparing the cognitive style prediction for the training data to a known cognitive style for the training user, and updating weights or values of hidden states of the machine learning system to minimize a loss between the cognitive style prediction for the training data and the known cognitive style for the training user.

20. The system as recited in claim 18, the user interaction information for a user interaction including:
an indication of a type of the user interaction;
a representation of the content; and
an indication of a modality of the content.
